(19) United States
(12) Patent Application Publication
(10) Pub. No.: US 2006/0150333 A1
(43) Pub. Date: Jul. 13, 2006

(54) Medical apparatus

(75) Inventor: Richard Paul Harding, Worthing (GB)

Correspondence Address: LOUIS WOO;LAW OFFICE OF LOUIS WOO, 717 NORTH FAYETTE STREET, ALEXANDRIA, VA, 22314, US

(73) Assignee: Eschmann Holdings Limited, Lancing (GB)

(21) Appl. No.: 10/528,015

(22) PCT Filed: Oct. 3, 2003
(86) PCT No.: PCT/GB03/04283

§ 371 Date: Oct. 24, 2005

(30) Foreign Application Priority Data
Oct. 4, 2002 (GB) 0223098.5

(51) Int. Cl. A61G 13/08

(52) U.S. Cl. 5/618; 5/616

(57) ABSTRACT

A medical apparatus having first and second relatively movable parts, a drive means for causing relative movement therebetween, and control means for controlling the operation of drive means, the control means including a sensor for detecting the relative position of the first and second parts, the control means including at least one of an acceleration control system and a deceleration control system, the acceleration control system having a first acceleration control for operating the drive means in a first acceleration phase in which the relative position is periodically detected and power fed to the drive means is increased using a preset power increase protocol until relative motion between the first and second parts is detected by the sensor, and a second acceleration control for operating the drive means in a second acceleration phase, after the first acceleration phase, in which the relative speed between the first and second parts is accelerated up to a set speed value at a set acceleration rate, and the deceleration control system includes a deceleration control for operating the respective drive means in a deceleration phase in which power fed to the drive means is decreased using a preset power decrease protocol.

This invention relates to a medical apparatus having relatively movable parts and to a method of moving the relatively movable parts of such a medical apparatus. The invention in particular relates to a surgical table and to a method of operating a surgical table.

Surgical tables usually have a patient support mounted at the upper end of a column, the height of which can be adjusted. The table is usually capable of adjusting the angle of the support both about a longitudinal axis and about a transverse axis. The support is usually divided into a number of different sections, such as a head section, a torso section and a leg section. The torso section is usually divided into two parts, the angle of which can be adjusted relative to one another about a transverse axis. In most cases, the different sections are connected with the column or with other sections by struts the length of which can be adjusted so that the angle of the sections can be adjusted. These struts may be hydraulic actuators or electrically-driven screw actuators.

It is also known from WO-A-02/05501 to provide a surgical table having a patient support member mounted at the upper end of a column, the support member having at least two sections along its length, the two sections being mounted with one another on opposite sides of the table by respective gear means, each gear means including respective drive means for rotating the gear means about a common transverse axis, and the table including means for controlling operation of the two drive means so that they rotate the respective gear means through the same angle. Each drive means may include an electric motor and the means for controlling operation of the drive means may include a sensor, such as an optical sensor, responsive to rotation of the gear means.

For some surgical tables, it is necessary to provide respective drive and associated gear means along opposite sides of the table when it is required to provide a longitudinally central part of the patient support surface to be transparent to x-rays, otherwise mechanical parts straddling the width of the table would interfere with the x-ray image of the patient on the support surface. It is difficult accurately to control the operation of the two drive and associated gear means so that they are fully in synchronism.

Furthermore, for many operating tables it is also difficult to control the drive and associated gear means so that they do not impart a jerky motion to the part of the surgical table being moved. A jerky or kicking initial motion is particularly encountered using hydraulic actuators for achieving relative movement of adjacent table parts. This can cause discomfort to the patient, sometimes with serious medical consequences. This problem tends to be encountered by surgical tables because the load required to be supported by the table, i.e. the weight of the patient, can vary significantly, typically from less than 50 to more than 150 kg. When the table is carrying a lightweight patient, the drive systems tend to move in a more jerky manner than for a heavy patient, because of the reduced load on the drive systems.

In addition, for some surgical tables, it would be desirable for the movement of the table drive systems to be individually configurable to the needs of the specific surgical or medical team or procedure. Known surgical tables have a preset drive system which determines the speed and acceleration of the movable table parts, and cannot be adjusted readily by the user.

Other medical apparatus, apart from surgical tables, have relatively movable parts. For example, patient beds, operating table transfer systems, patient chairs etc. may all be provided with relatively movable parts which are motor driven to vary the orientation of support parts or support surfaces. For this medical apparatus as well, it would be desirable to control any drive and associated gear means so that they do not impart a jerky motion to the part of the medical apparatus being moved. Furthermore, for such medical apparatus it would be desirable too for the movement of the drive system to be individually configurable.

The present invention aims at least partially to overcome at least some of these problems in the prior art.

The present invention provides a medical apparatus having first and second relatively movable parts, a drive means for causing relative movement therebetween, and control means for controlling the operation of drive means, the control means including a sensor for detecting the relative position of the first and second parts, the control means including at least one of an acceleration control system and a deceleration control system, the acceleration control system having a first acceleration control for operating the drive means in a first acceleration phase in which the relative position is periodically detected and power fed to the drive means is increased using a preset power increase protocol until relative motion between the first and second parts is detected by the sensor, and a second acceleration control for operating the drive means in a second acceleration phase, after the first acceleration phase, in which the relative speed between the first and second parts is accelerated up to a set speed value at a set acceleration rate, and the deceleration control system includes a deceleration control for operating the respective drive means in a deceleration phase in which power fed to the drive means is decreased using a preset power decrease protocol.

The present invention also provides a method of operating a medical apparatus having first and second relatively movable parts which are relatively movable by a drive means, and a control means for controlling the operation of the drive means, the control means including a sensor for detecting the relative position of the first and second parts, the method comprising at least one of an acceleration phase and a deceleration phase, the acceleration phase comprising the steps of: (a) operating the drive means in a first acceleration phase in which the relative position is periodically detected and power fed to the drive means is increased using a preset power increase protocol until relative motion between the first and second parts is detected by the sensor; and (b) operating the drive means in a second acceleration phase, after the first acceleration phase, in which the relative speed between the first and second parts is accelerated up to a set speed value at a set acceleration rate; and the deceleration phase comprising the step of: (c) decreasing power fed to the drive means using a preset power decrease protocol.

Embodiments of the present invention will now be described, by way of example, with reference to the accompanying drawings, in which:

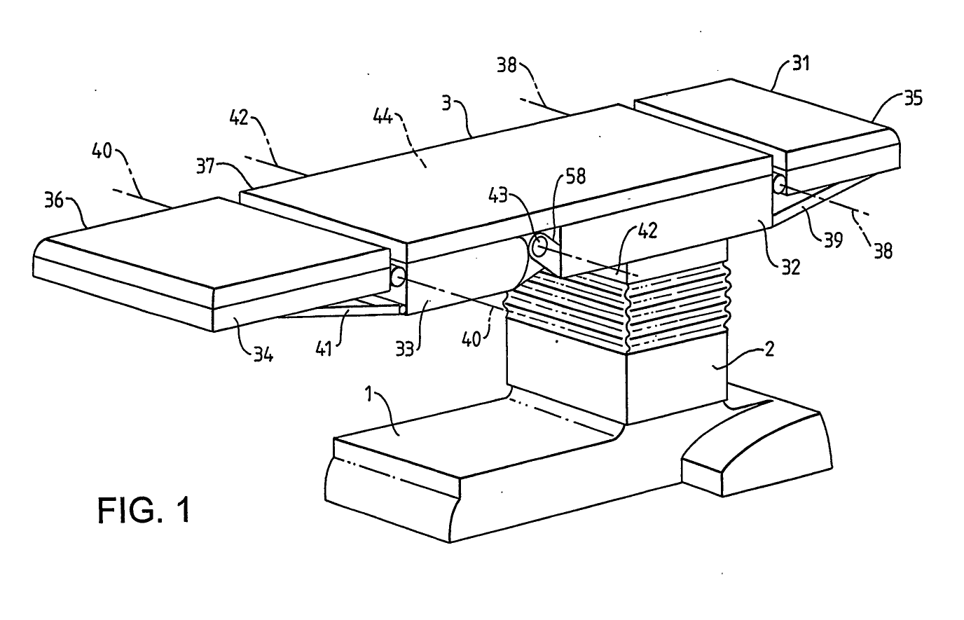

FIG. 1 is a perspective view of a surgical table in accordance with an embodiment of the present invention;

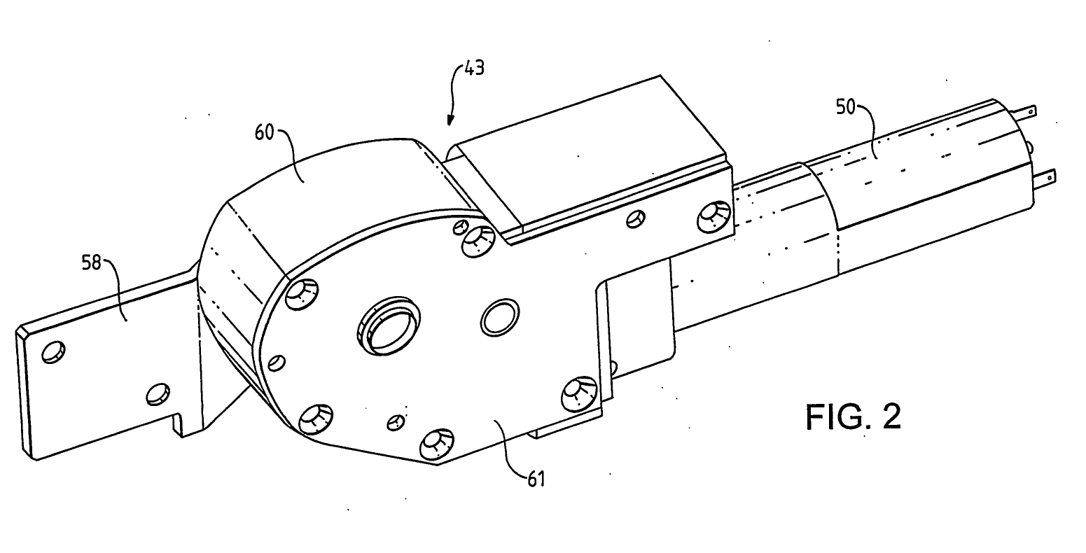

FIG. 2 is a perspective view of a coupling between two sections of the table top;

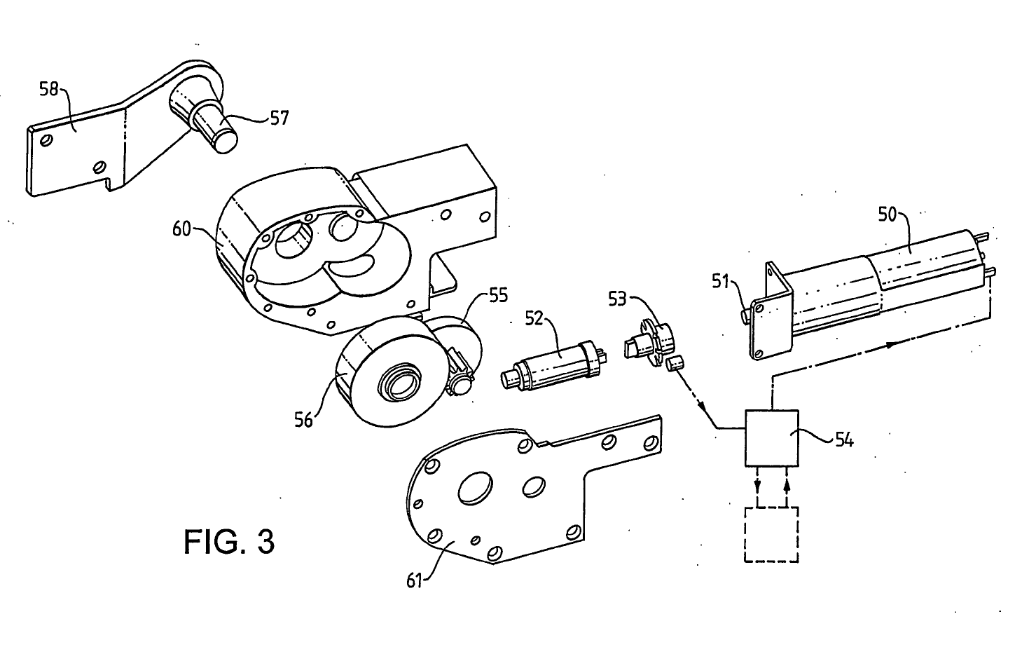

FIG. 3 is an exploded view of the coupling shown in FIG. 2;

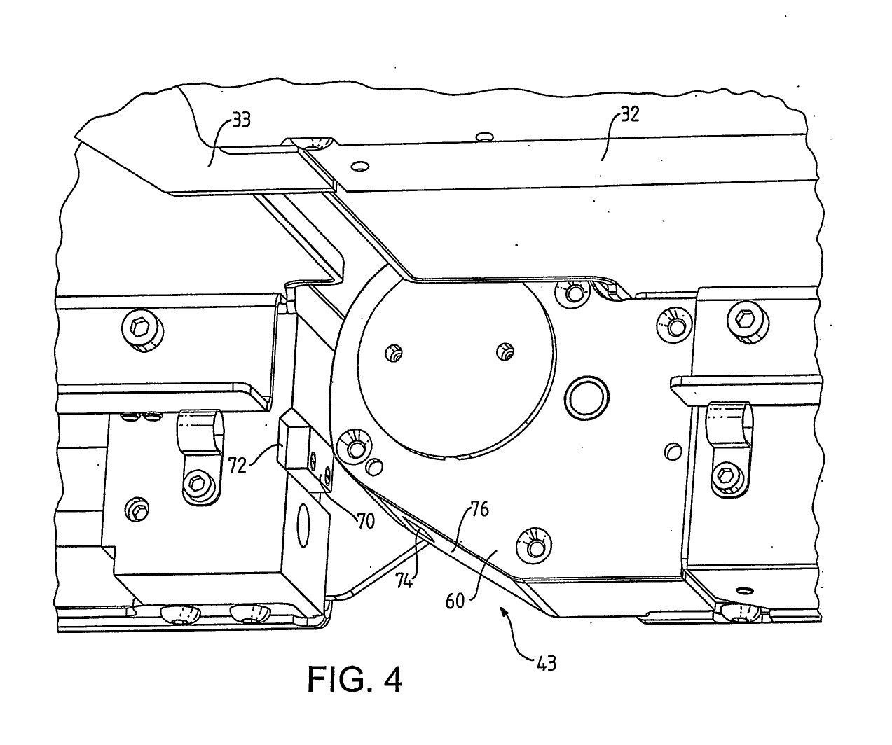

FIG. 4 is a perspective view from below of an inner side of one of the couplings of FIG. 3;

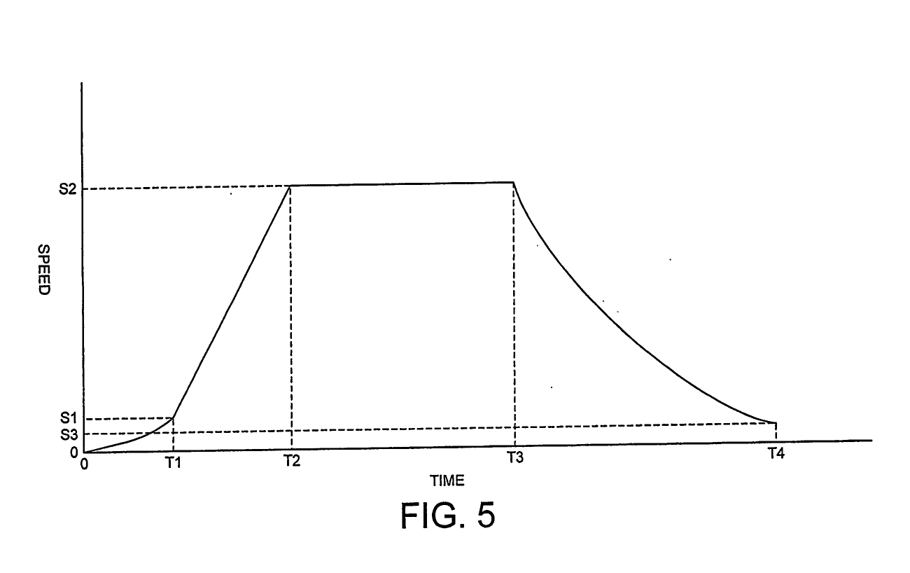

FIG. 5 is a graph showing the relationship between speed and time for a table part which is moved by drive means and associated gear means of a table in accordance with an embodiment of the present invention; and

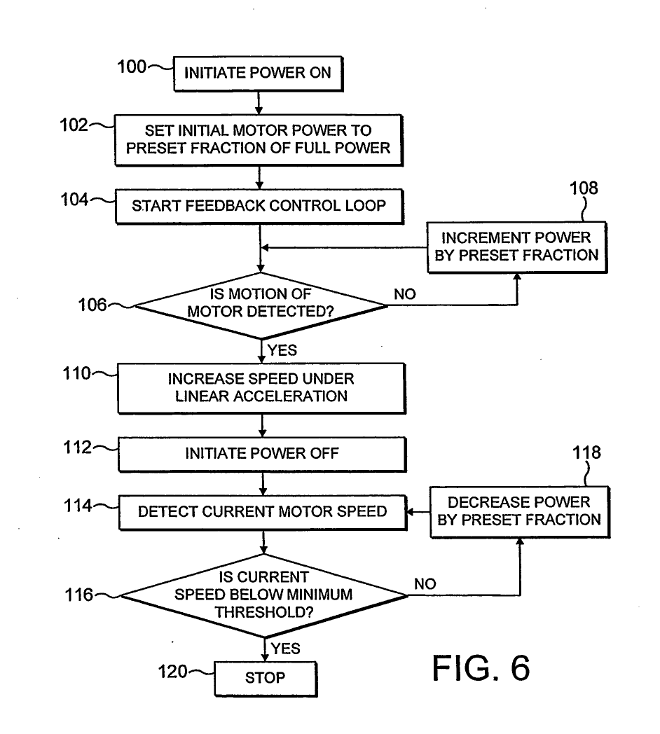

FIG. 6 is a process flow for the control of the drive means and associated gear means in accordance with the embodiment of the invention for implementing the relationship shown in FIG. 5.

With reference first to FIG. 1, the table includes a base 1, which stands on the floor, a column 2 of adjustable height mounted on the base and a table top 3 providing a patient support surface 4.

The table top 3 is divided into four sections, namely a head section 31, an upper torso section 32, a lower torso section 33 and a leg section 34. The head and leg sections 31 and 34 each have a separate mattress 35 and 36, whereas the two torso sections 32 and 33 have common mattress 37 extending along the length of both sections. The lower end of the head section 31 is mounted on the upper end of the upper torso section 32 by means of a conventional pivot joint so that it can be displaced about a transverse axis 38. The angle of the head section 31 is controlled by means of a pair of conventional adjustable struts 39, only one of which is shown, extending between the underside of the head section and the upper torso section 32, one on each side. The struts may be hydraulic or electric actuators. The leg section 34 is similarly mounted at the lower end of the lower torso section 33 for displacement about a transverse axis 40 by means of two struts 41 secured at opposite ends to the two sections.

The lower torso section 33 can also be displaced relative to the upper torso section 32 about a transverse axis 42 by means of two electrically-driven rotary gear mechanisms 43 and 44 on opposite sides of the table. The two gear mechanisms 43 and 44 have the same construction as one another except that one is a mirror image of the other (the bodies of the two drives are mirrored but the drive chains within the bodies are identical (not mirrored) so that the motors turn in the same direction to move the section up or down) so only one mechanism 43 will be described, with reference to FIGS. 2 and 3. The mechanism 43 includes an electric motor 50 incorporating an in line gearbox and arranged substantially longitudinally of the table and having its output shaft 51 connected to a worm gear 52 via an optical pick-off 53, which provides an output to a control unit 54 representative of the speed and extent of rotation of the motor shaft. The worm gear 52 meshes with the edge of a reduction gear 55 arranged for rotation about a transverse axis and which meshes with the edge of a main gear wheel 56, The worm gear 52 acts onto a wheel gear (not shown) with a 38:1 reduction, this wheel gear being on the same shaft and locked to, by means of a key, a small spur gear which meshes with the output gear 56 with a ratio of 3.8:1. The main gear wheel 56 is fixed on a stub 57 projecting from the inside surface of a side plate 58 so that the gear wheel and stub rotate together. The side plate 58 is attached with the side of the upper torso section 32. The gears 52, 55 and 56, and the pick-off 53 are mounted in a gear mechanism housing 60 having a side plate 61. The motor 50 is secured on this housing 60 and projects therefrom. The housing 60 is secured with the side of the lower torso section 33.

It can be seen that, as the motor 50 is rotated it rotates the worm gear 52 and that this in turn rotates the reduction gear 55 via the wheel gear. Typically, about 38 rotations of the motor 50 are required to rotate the reduction gear 55 through one complete revolution. The reduction gear 55 in turn rotates the main gear wheel 56. Typically, about 3.8 rotations of the reduction gear 55, that is, 144.4 rotations of the motor 50, are required to rotate the main gear wheel 56 through one complete revolution. The gear mechanism 43 is arranged such that the main gear wheel 56 is rotatable through an angle of about 140°, so that the lower torso section 33 can be raised through an angle of up to 90° above the upper torso section 32 and can be lowered through an angle of up to 50° below the upper torso section.

The motor in the gear mechanism 44 on the opposite side of the table is driven in the same sense to produce the same rotation of the gear mechanism. This is achieved by the control unit 54, which compares the pick-off outputs from the two gear mechanisms 43 and 44 and alters power supply to one or both motors accordingly to produce rotation of the two gear mechanisms through the same angle.

Referring to FIG. 4, the gear mechanism 43 is further provided with a sensor 70 which is used to provide a calibration reference point for the angular position of the gear mechanism 43, and correspondingly the relative angular positions of the lower torso section 33 and the upper torso section 32. The sensor 70, which may be a contact or a non-contact sensor, comprises in the illustrated embodiment a reed switch 70 which is mounted on an end 72 of the lower torso section 33, in combination with an actuator for the reed switch 70, which actuator comprises a magnet 74 disposed on or recessed in an outer surface 76 of the gear mechanism housing 60, the housing 66 in turn being mounted on the upper torso section 32. The reed switch 70 is triggered when the magnet 74 passes thereby, in this way providing a signal corresponding to a calibration reference point for the angular position of the sections 33,32. The calibration reference point may also be used in combination with the control unit to provide diagnostic information as to the calibration status. In the illustrated embodiment, the sensor comprises a reed switch, but alternatively may comprise a potentiometer, a microswitch or an optical device, thereby being a contact or non-contact sensor.

In a further embodiment, the drive means, comprising the electric motor 50, may include a tachometer, which typically may comprise a Hall effect device, which is adapted to count the number of rotations of the motor, thereby to provide additional positional and speed feedback information to the control unit, by means of a digital output signal. This provides enhanced accuracy of the positional control of the sections of the table.

The arrangement of the present invention enables relatively large relative movements between two sections of a surgical table. It also has the advantage of being relatively compact and of not obstructing space beneath the table, under the patient. This can be an advantage if access is required by imaging equipment.

The gear mechanisms of the present invention need not be driven by electric motors but could be driven, for example, by hydraulic motors.

Referring to FIG. 5 there is shown a graph showing the relationship between speed and time for a table part which is moved by drive means, such as motor 50, and associated gear mechanism, such as gears 52,55,56, of a surgical table in accordance with an embodiment of the present invention. The parts to be mutually relatively moved may be any parts of the table which are configured to be moved, such as any section(s) of the patient support surface, or the patient support surface as a whole, or the column.

Initially at time T=0, the speed S=0. The speed S may be angular speed, when for example the inclination of a part of the patients support surface is being changed, or linear speed, when for example the patient support surface is being raised or lowered by the operation of the column. When switching ON the requisite drive means, the speed of movement is increased slowly by an exponential relationship at a relatively low acceleration until a time T1 and a speed S1. Thereafter, the speed increases linearly under a constant acceleration, which is relatively high compared to the exponential acceleration, up to the required set speed S2 which is achieved at a time T2. Thereafter, the movement continues at the desired set speed S2 until a time T3 when the drive means is switched OFF. Thereafter, the speed decelerates down to zero again by an exponential decay deceleration curve. At a minimum threshold detected speed S3, the control of the speed is terminated at time T4.

The process flow for the control of the drive means is shown in FIG. 6.

In step 100, the power supply for the motor 50 is turned ON. For the initial exponential acceleration, in step 102 the initial power supplied to the drive means (motor 50) is preset to a pre-selected fraction of the full power of the drive means which is sufficient to initiate movement of the respective part of the surgical table to be moved when that part is not carrying a load (i.e. a patient). The drive means is provided with a feedback control which detects movement of the drive means, based on an input signal from the sensor 70. The feedback control is employed in a periodic control loop having a preset cycle frequency, typically about 160 milliseconds, as shown in step 104. For each feedback control cycle, a determination is made as to whether or not the drive means has initiated movement which has been detected by the sensor 70, as shown in step 106. In the feedback control loop, the output of the sensor 70 provided with each gear mechanism 52,55, 56 is continually detected and employed to calculate the speed and motion of the gear mechanism, and consequentially the relative speed between the parts being moved. The sensor may comprise a potentiometer, providing a ratiometric return voltage signal which is dependent on the angular position of the gear mechanism, which signal may be readily calibrated. Any change in position from the previous loop can be employed to determine whether movement of the respective gear mechanism has been detected and to calculate the average speed of movement.

The drive means typically comprises an electric motor driven by a pulse width modulated signal, the width of the pulse determining the amount of power supplied to the electric motor. If no movement of the drive means has been detected after the first loop, then as shown in step 108, for the next control loop the power supplied to the motor is increased, by increasing the pulse width, by a pre-selected fraction, typically from 25 to 33%, most typically 25%, of the current power supplied to the motor. This feedback control loop is cycled until motion of the motor is detected. This power control protocol causes an exponential increase of the initial speed of the motor.

When motion of the motor is detected, at time T1 and speed S1, the speed of the motor is thereafter accelerated linearly up to the set speed S2 at time T2, as shown in step 110.

However, if the motor is one of a pair of motors configured to cooperate in synchronism, for example the two motors being disposed on opposed sides of the table patient support surface for driving a common section of the patient support surface, then for each motor the initiation of linear acceleration is only established after both motors have been detected as being in motion by a respective feedback control loop.

Both the exponential and the linear acceleration rates may readily be variable by a user or service engineer, for example by providing an appropriate control knob on the table control panel. This enables a user or service engineer to “customise” the rate of movement of the movable parts of the table as required.

In the linear acceleration phase, the linear acceleration rate is typically preset for each motor, most typically being around 5 to 10% of full power.

When it is desired to turn the motor(s) off, after the motor has been switched OFF as shown in step 112, the power fed to the motor(s) is decreased by a pre-selected fraction of the current power per feedback control loop so as to achieve an exponential decay in speed. For example, for successive control loops having a feedback control period of 160 milliseconds, the power for the succeeding loop is cut by the fraction of from 33 to 50%, most typically about ⅓, compared to the power for the preceding loop. Again, this deceleration rate can be varied by the user or service engineer, for example by the operation of a control on the control panel. This enables a user or service engineer to “customise” the deceleration or stopping characteristics of the movable parts of the table.

As shown in FIG. 6, in step 114 the current motor speed is detected, and then in step 116 a determination is made as to whether or not the detected speed is below a minimum threshold. If not, the power to the motor(s) is decreased in step 118 by the preset fraction, and then the current sped is again detected in step 114 in the next control loop cycle. When the detected current speed is below the minimum threshold, then the control loop is stopped in step 120.

As shown in FIG. 5, this control of the acceleration and deceleration of the movement of various parts of the table provides a “slow” start and a “slow” stop facility for the drive means for those parts. The start protocol has an exponentially increasing first phase of relatively low acceleration before a second phase of relatively high linear acceleration up to the preset motor speed. The stop protocol has an exponentially decaying acceleration from the preset motor speed.

For both the starting and stopping movements, an error facility may be provided. For example, on the starting motion, if at a pre-selected high power input to the motor no movement of the motor is detected, an error signal is produced. Similarly, in the stopping motion, if no movement is detected, after switching of the OFF switch, power is automatically shut off without the exponential decay.

When two drives and gear mechanisms are intended to be operated in synchronism, each drive means is provided with a target speed, and a target speed difference between the speeds of the two motors is preset. The feedback control loop is employed to apply adjustment factors to meet both of these criteria. When for example the drive means and gear mechanism are employed to cause synchronisation between the upper and lower torso sections of the table top, typically the motor drives on the opposed sides of the tables are controlled so as to be in synchronism with a target angular difference of ±0.5°, with a maximum target angular difference of ±1°.

The embodiments of the present invention provide the advantage that it is readily possible to control the drive and associated gear means so that they do not impart a jerky motion to the part of the surgical table being moved, even when the load required to be supported by the table, i.e. the weight of the patient, can vary significantly, typically from less than 50 to more than 150 kg. Furthermore, the movement of the table drive system can be individually configurable to the needs of the specific surgical or medical team or procedure, and can be adjusted readily by the user. The embodiments of the present invention also provide the advantage that for surgical tables where respective drive and associated gear means are provided along opposite sides of the table, it is possible accurately to control the operation of the two drive and associated gear means so that they are fully in synchronism.

Although the illustrated embodiments of the invention concern the structure and operation of surgical tables, the invention is applicable generally to medical apparatus and methods of operating such apparatus, having relatively movable parts, for example, patient beds, patient chairs and operating table transfer systems. The apparatus and method of the invention can be employed to control the raising and lowering of a bed, the raising and lowering of an inclined head portion of a bed, the raising and lowering of the seat and/or back of a chair, the raising and lowering of the inclination of a chair, and the raising and lowering of an operating table transfer system, for example, so that for each movement a jerky motion is avoided. Furthermore, as for surgical tables, the movement of the drive systems can be individually configurable to the needs of the specific application or user.

Furthermore, although the embodiments of the present invention control both the starting (acceleration) and stopping (deceleration) of the relatively movable parts, either the starting motion or the stopping motion or both may be controlled in accordance with the invention.

Furthermore, in accordance with the invention, the sequence of movement of the relatively movable parts of the medical apparatus may be variable by a user or service engineer.

1. A medical apparatus having first and second relatively movable parts, a drive means for causing relative movement therebetween, and control means for controlling the operation of drive means, the control means including a sensor for detecting the relative position of the first and second parts, the control means including at least one of an acceleration control system and a deceleration control system, the acceleration control system having a first acceleration control for operating the drive means in a first acceleration phase in which the relative position is periodically detected and power fed to the drive means is increased using a preset power increase protocol until relative motion between the first and second parts is detected by the sensor, and a second acceleration control for operating the drive means in a second acceleration phase, after the first acceleration phase, in which the relative speed between the first and second parts is accelerated up to a set speed value at a set acceleration rate, and the deceleration control system includes a deceleration control for operating the respective drive means in a deceleration phase in which power fed to the drive means is decreased using a preset power decrease protocol.

2. A medical apparatus according to claim 1 wherein the first acceleration control includes means for setting the initial power fed to the drive means at a pre-selected value, means for operating a feedback control loop in which a signal from the sensor is employed to determine whether there is relative motion between the first and second parts, and means for incrementing the power fed to the drive means by a pre-selected amount if such relative motion is undetected.

3. A medical apparatus according to claim 2 wherein the feedback control loop has a period of about 160 milliseconds.

4. A medical apparatus according to claim 2 wherein the means for incrementing is adapted to increase the power by a first pre-selected fraction of the current power supplied to the drive means.

5. A medical apparatus according to claim 4 wherein the first pre-selected fraction is from 25 to 33% of the current power supplied to the drive means.

6. A medical apparatus according to claim 1 wherein in the second acceleration phase the set acceleration rate is linear.

7. A medical apparatus according to claim 1 further comprising means for varying at least the set acceleration rate.

8. A medical apparatus according to claim 1 wherein the deceleration control is adapted to decrease power fed to the drive means by a second pre-selected fraction of the current power supplied to the drive means.

9. A medical apparatus according to claim 8 wherein the second pre-selected fraction is from 33 to 50% of the current power supplied to the drive means.

10. A medical apparatus according to claim 1 which is a surgical table having a patient support member and wherein the first and second parts comprise a lower torso section and an upper torso section of the patient support member.

11. A medical apparatus according to claim 1 which is a surgical table having a patient support member mounted at an upper end of a column, the support member having at least two sections along its length, the two sections being relatively movable by a first drive means, and the support member being movable relative to the column by a second drive means, and the control means being adapted to control the operation of at least one of the first and second drive means.

12. A medical apparatus according to claim 10 wherein the first and second parts are mounted with one another by respective first and second gear means disposed on opposite sides of the table, each gear means is coupled with a respective one of first and second motors for rotating the respective gear means about a common transverse axis, and respective first and second sensors are associated with the first and second gear means and motors, and the control means are adapted to control the operation of the first and second motors so that they rotate the respective gear means through the same angle.

13. A medical apparatus according to claim 12 wherein the control means is adapted whereby the second acceleration phase is only established for each of the first and second motors when both the first and second gear means and motors have been detected as being in motion by the respective sensor of the first and second sensors.

14. A medical apparatus according to claim 1 wherein the motor is an electric motor.

15. A method of operating a medical apparatus having first and second relatively movable parts which are relatively movable by a drive means, and a control means for controlling the operation of the drive means, the control means including a sensor for detecting the relative position of the first and second parts, the method comprising at least one of an acceleration phase and a deceleration phase, the acceleration phase comprising the steps of:
(a) operating the drive means in a first acceleration phase in which the relative position is periodically detected and power fed to the drive means is increased using a preset power increase protocol until relative motion between the first and second parts is detected by the sensor; and
(b) operating the drive means in a second acceleration phase, after the first acceleration phase, in which the relative speed between the first and second parts is accelerated up to a set speed value at a set acceleration rate; and the deceleration phase comprising the step of:
(c) decreasing power fed to the drive means using a preset power decrease protocol.

16. A method according to claim 15 wherein in the first acceleration phase the initial power fed to the drive means is set at a pre-selected value, and a feedback control loop is operated in which a signal from the sensor is employed to determine whether there is relative motion between the first and second parts, and the power fed to the drive means is incremented by a pre-selected amount if such relative motion is undetected.

17. A method according to claim 16 wherein the feedback control loop has a period of about 160 milliseconds.

18. A method according to claim 16 wherein the power is incremented by a first pre-selected fraction of the current power supplied to the drive means.

19. A method according to claim 18 wherein the first pre-selected fraction is from 25 to 33% of the current power supplied to the drive means.

20. A method according to claim 15 wherein in the second acceleration phase the set acceleration rate is linear.

21. A method according to claim 15 wherein at least the set acceleration rate is variable.

22. A method according to claim 15 further comprising the step of operating the respective drive means in a deceleration phase in which power fed to the respective drive means is decreased using a preset power decrease protocol.

23. A method according to claim 22 wherein the power fed to the respective drive means is decreased by a second pre-selected fraction of the current power supplied to the drive means.

24. A method according to claim 23 wherein the pre-selected fraction is from 33 to 50% of the current power supplied to the drive means .

25. A method according to claim 15 wherein the medical apparatus is a surgical table having a patient support member and the first and second parts comprise a lower torso section and an upper torso section of the patient support member.

26. A method according to claim 15 wherein the medical apparatus is a surgical table having a patient support member mounted at an upper end of a column, the support member having at least two sections along its length, the two sections being relatively movable by a first drive means, and the support member being movable relative to the column by a second drive means, and the control means controlling the operation of at least one of the first and second drive means.

27. A method according to claim 25 wherein the first and second parts are mounted with one another by respective first and second gear means disposed on opposite sides of the table, each gear means is coupled with a respective one of first and second drive means for rotating the respective gear means about a common transverse axis, and respective first and second sensors are associated with the first and second gear and drive means, and the control means are adapted to control the operation of the first and second drive means so that they rotate the respective gear means through the same angle.

28. A method according to claim 27 wherein the second acceleration phase is only established for each drive means when both the first and second gear means and drive means have been detected as being in motion by the respective sensor of the first and second sensors.

29. (canceled)

30. (canceled)
